(19) United States
(12) Patent Application Publication
(10) Pub. No.: US 2026/0235836 A1
(43) Pub. Date: Aug. 13, 2026

(54) MULTICORE OPTICAL WIRING MODULE

(71) Applicant: NTT, Inc., Tokyo (JP)

(72) Inventors: Chisato FUKAI, Musashino-shi, Tokyo (JP); Yoshiteru ABE, Musashino-shi, Tokyo (JP); Ryo KOYAMA, Musashino-shi, Tokyo (JP); Hiroshi WATANABE, Musashino-shi, Tokyo (JP); Kuniaki TERAKAWA, Musashino-shi, Tokyo (JP); Tomohiro KAWANO, Musashino-shi, Tokyo (JP); Saki NOZOE, Musashino-shi, Tokyo (JP); Akihiro KURODA, Musashino-shi, Tokyo (JP); Kazunori KATAYAMA, Musashino-shi, Tokyo (JP); Ikutaro OGUSHI, Musashino-shi, Tokyo (JP)

(21) Appl. No.: 19/151,710

(22) PCT Filed: Feb. 21, 2023
(86) PCT No.: PCT/JP2023/006165

§ 371 Date: Jul. 29, 2025

(51) Int. Cl. G02B 6/44

(52) U.S. Cl. CPC G02B 6/4452

(57) ABSTRACT

A multi-core optical wiring module includes a plurality of plate-shaped optical wiring paths having one or more optical paths provided therein, wherein the plurality of optical wiring paths are stacked in a thickness direction.

### TECHNICAL FIELD

The present disclosure relates to a multi-core optical wiring module.

### BACKGROUND ART

In information networks, the Internet is widely used, and transmission capacity is expanding year by year. For this reason, a large number of communication devices are arranged not only in communication base stations by conventional communication companies, but also in data centers, portable base stations, and the like. The communication devices are connected by an optical fiber cable in a communication area which cannot be dealt with by a metal wire because of a high communication speed.

As a technique for efficiently connecting communication devices, a technique described in NPL 1 or NPL 2 can be cited. NPL 1 discloses a splitter in which there exists a path on a glass plane through which communication light propagates, and one input branches into eight outputs. NPL 2 discloses a polymer optical waveguide in which a plurality of parallel paths are made of a soft material such as polymer, and describes that the optical waveguide can be freely formed by connecting the polymer optical waveguides.

### CITATION LIST

### Non Patent Literature

[NPL 1] NTT Access Service Systems Laboratories, PLC technology for optical access, Internet <URL:https://www.rd.ntt/as/history/access/ac0108.html>
[NPL 2] Sumitomo Bakelite Co., Ltd., Polymer optical waveguide, Applications of optical waveguide, Internet <URL:https://www.sumibe.co.jp/product/coin/coin003/index.html>

### SUMMARY OF INVENTION

### Technical Problem

In the techniques described in NPL 1 and NPL 2, the connection between optical fibers needs to be formed in a one-dimensional array, wherein crosstalk occurs when the transmission paths are close to each other and intersect with each other. Therefore, although these techniques can form a transmission path having a simple structure, a plurality of intersecting portions need to be arranged so as not to be close to each other when connecting the multi-core optical connectors, and consequently the circuit becomes large.

An object of the present disclosure is to provide a multi-core optical wiring module that can be downsized while suppressing the occurrence of crosstalk.

### Solution to Problem

A multi-core optical wiring module according to the present disclosure includes a plurality of plate-like optical wiring paths in which one or more optical paths are provided, wherein the plurality of optical wiring paths are stacked in a thickness direction.

### Advantageous Effects of Invention

According to the multi-core optical wiring module according to the present disclosure, it is possible to provide a multi-core optical wiring module that can be downsized while suppressing the occurrence of crosstalk.

### BRIEF DESCRIPTION OF DRAWINGS

FIG. 1 is a diagram showing an example of a form of connection of a multi-core optical wiring module according to a first embodiment.

FIG. 2 is a diagram showing a configuration example of the multi-core optical wiring module according to the first embodiment.

FIG. 3 is a diagram showing a configuration example of the multi-core optical wiring module according to the first embodiment.

FIG. 4 is a diagram showing a configuration example of an optical wiring path according to the first embodiment.

FIG. 5 is a diagram showing another configuration example of the optical wiring path according to the first embodiment.

FIG. 6 is a diagram showing an example of an image representing an optical connection portion of a first side surface of the optical wiring path according to the first embodiment.

FIG. 7 is a diagram showing an example of an image representing an optical connection portion of a second side surface of the optical wiring path according to the first embodiment.

FIG. 8 is a diagram showing another example of an image representing the optical connection portion of the second side surface of the optical wiring path according to the first embodiment.

FIG. 9 is a diagram showing an example of an image representing a connection end face between the optical wiring path according to the first embodiment and the optical connection portion.

FIG. 10 is a diagram showing an example of an image representing a connection end face between the optical wiring path according to the first embodiment and the optical connection portion.

FIG. 11 is a diagram showing an example of a form of connection of a multi-core optical wiring module according to a second embodiment.

FIG. 12 is a diagram showing a configuration example of a first side surface of the multi-core optical wiring module according to the second embodiment.

FIG. 13 is a diagram showing a second side surface of the multi-core optical wiring module according to the second embodiment.

FIG. 14A is a diagram showing an example of a configuration of an optical wiring path according to the second embodiment.

FIG. 14B is a diagram showing an example of the configuration of the optical wiring path according to the second embodiment.

FIG. 14C is a diagram showing an example of the configuration of the optical wiring path according to the second embodiment.

FIG. 14D is a diagram showing an example of the configuration of the optical wiring path according to the second embodiment.

FIG. 14E is a diagram showing an example of the configuration of the optical wiring path according to the second embodiment.

FIG. 14F is a diagram showing an example of the configuration of the optical wiring path according to the second embodiment.

FIG. 14G is a diagram showing an example of the configuration of the optical wiring path according to the second embodiment.

FIG. 14H is a diagram showing an example of the configuration of the optical wiring path according to the second embodiment.

FIG. 15 is a diagram showing an example of a form of connection of a multi-core optical wiring module according to a third embodiment.

FIG. 16 is a diagram showing a configuration example of a first side surface and a third side surface of the multi-core optical wiring module according to the third embodiment.

FIG. 17 is a diagram showing a second side surface and a side surface of a fourth side surface of the multi-core optical wiring module according to the third embodiment.

FIG. 18A is a diagram showing an example of a configuration of an optical wiring path according to the third embodiment.

FIG. 18B is a diagram showing an example of the configuration of the optical wiring path according to the third embodiment.

FIG. 18C is a diagram showing an example of the configuration of the optical wiring path according to the third embodiment.

### DESCRIPTION OF EMBODIMENTS

Hereinafter, several embodiments will be described in detail with reference to the drawings. In the descriptions, the same portions are assigned the same reference numerals, and descriptions thereof will be omitted accordingly.

### First Embodiment

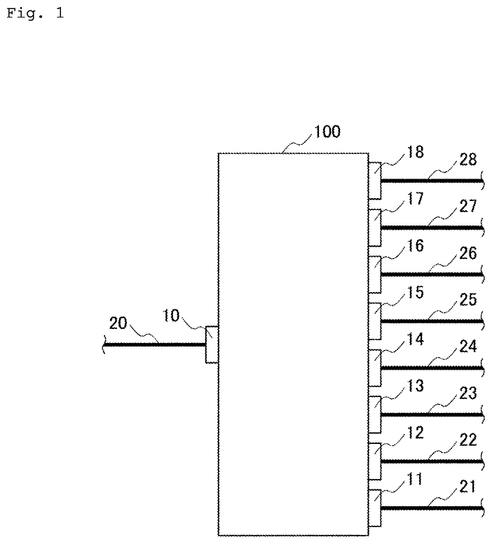

FIG. 1 is a diagram showing an example of a form of connection of a multi-core optical wiring module 100 according to a first embodiment. As shown in FIG. 1, the multi-core optical wiring module 100 connects a multi-core optical connector 10 and multi-core optical connectors 11 to 18 to realize optical communication between an optical fiber cable 20 and optical fiber cables 21 to 28.

As the multi-core optical connectors 10 to 18, for example, an MT connector, also referred to as an F12-type multi-core optical fiber connector, may be used. The optical fiber cables 20 to 28 to be attached to the MT connector are bonded and fixed to optical fiber insertion holes of MT ferrules. Connection end faces of core wires of the optical fiber cables 20 to 28 are polished at right angle. The optical fiber cables 20 to 28 may be provided in pigtail. The MT connector is connected by filling the gap between the end faces with a refractive index matching agent, inserting a guide pin (not shown) attached to one MT ferrule into a guide pin hole (not shown) of the other MT ferrule, and fitting the MT ferrules For the multi-core optical connectors 10 to 18, an MPO connector, also referred to as an F13-type multi-core optical fiber connector, may be used in place of the MT connector. In this case, the end faces of the MT ferrules are polished obliquely, the MT ferrules are built in an MPO plug housing, and an MPO plug is connected in an MPO adapter. The multi-core optical connectors 10 to 18 may only be required to connect a plurality of optical fibers collectively and detachably, and are not limited to MT connector and MPO connector.

Although FIG. 1 shows a form of connecting one optical fiber cable 20 and eight optical fiber cables 21 to 28, the present disclosure is not limited thereto; one or more optical fiber cables may be connected to each other.

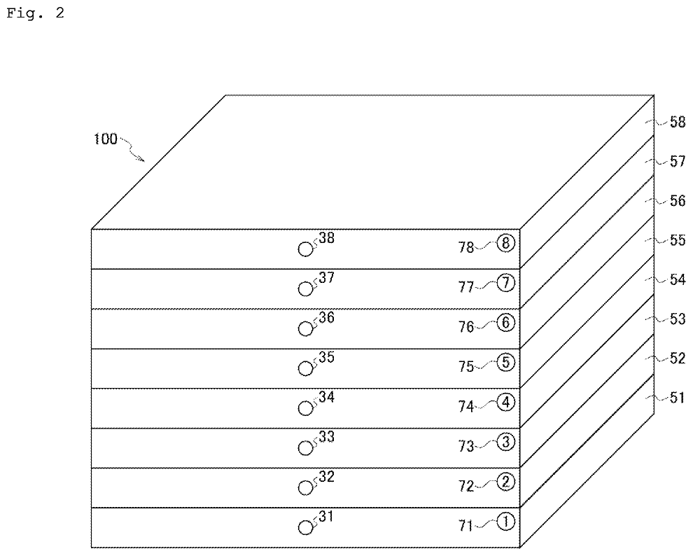

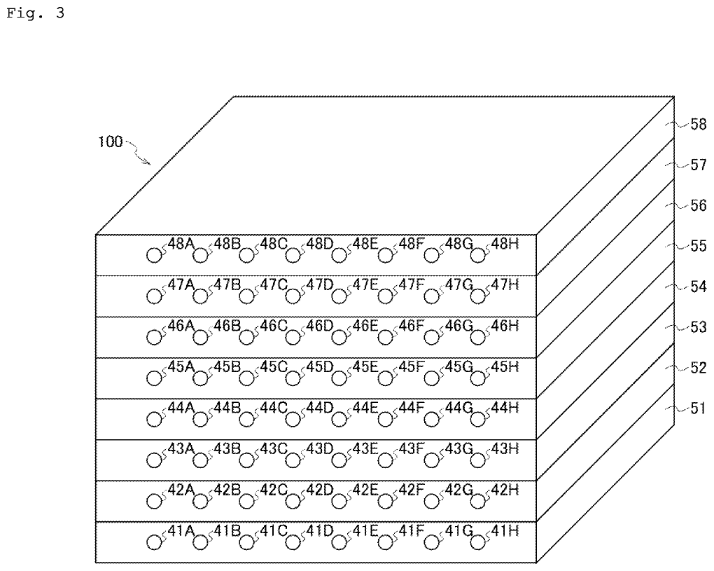

FIG. 2 is a diagram showing a configuration example of a first side surface of the multi-core optical wiring module 100. FIG. 3 is a diagram showing a second side surface facing the first side surface of the multi-core optical wiring module 100. The multi-core optical wiring module 100 is provided with a plurality of (eight, in FIGS. 2 and 3) optical wiring paths 51 to 58, optical paths 31 to 38, and optical paths 41A to 48H. In the multi-core optical wiring module 100, a plurality of optical wiring paths 51 to 58 having the same thickness are stacked and arranged in a thickness direction. The number of optical wiring paths 51 to 58 may be two or more, or can be arbitrarily set. Further, the respective optical wiring paths 51 to 58 may have different thicknesses.

One corresponding optical path 31 to 38 is provided on the first side surface of each of the optical wiring paths 51 to 58. The optical paths 31 to 38 of the adjacent optical wiring paths 51 to 58 are provided so as to be adjacent to each other in a straight line.

A plurality of (eight, in FIG. 3) corresponding optical paths 41A to 48H are provided in a straight line at equal intervals on the second side surface of each of the optical wiring paths 51 to 58. For example, in the optical wiring path 51, a plurality of (eight, in FIG. 3) corresponding optical paths 41A to 41H are provided in a straight line at equal intervals. Also, in the optical wiring path 52, a plurality of (eight, in FIG. 3) corresponding optical paths 42A to 42H are provided in a straight line at equal intervals. In the optical wiring paths 53 to 58 as well, the optical paths 43A to 48H are provided, as in the optical wiring paths 51, 52. The optical paths 41A to 48H of the adjacent optical wiring paths 51 to 58 are provided so as to be adjacent to each other in a straight line. For example, the optical paths 41A to 48A and the optical paths 41B to 48B of the adjacent optical wiring paths 51 to 58 are provided so as to be adjacent to each other in a straight line.

The optical paths 31 to 38 are connected to the optical fiber cable 20 through the multi-core optical connector 10 shown in FIG. 1. The optical paths 41A to 48H are connected to the optical fiber cables 21 to 28 through the multi-core optical connectors 11 to 18 shown in FIG. 1.

For example, the optical paths 31 to 38 and the optical paths 43A to 48H may be formed of optical fibers that are arranged with a level of bending where signal deterioration does not occur due to bending loss. For example, in a case where a single mode optical fiber whose bending loss does not increase with respect to bending of 30 mm radius is used, the optical fibers are bent and arranged in a size equivalent to a radius of 30 mm or more. For example, in a case where an optical fiber whose bending loss is reduced with respect to bending of 15 mm radius is used, the bending radius for arranging the optical fiber can be reduced to 15 mm. In this case, for example, the optical wiring paths 51 to 58 may be formed in a sheet shape of a material such as a polymer compound, and the optical fibers functioning as the optical paths may be arranged and filled with a resin.

The optical wiring paths 51 to 58 may be formed of a solid such as glass material, plastic solid, or metal. In a case where the optical wiring paths 51 to 58 are formed of a solid, the optical wiring paths 51 to 58 may be formed by manufacturing the respective optical wiring paths 51 to 58 in an upper portion and a lower portion, providing V grooves (not shown) in the respective optical wiring paths, arranging the optical fibers serving as the optical paths 31 to 38 along the V grooves, and bonding and fixing them. Although the V grooves are provided in the optical wiring paths 51 to 58, the present disclosure is not limited to this configuration. The optical wiring paths 51 to 58 may be formed by sandwiching the optical fibers, and the grooves may have a rectangular or curved surface shape.

Instead of constituting the optical paths 31 to 38 and the optical paths 43A to 48H with the optical fibers, the optical paths may be composed of optical waveguides. By providing a difference in refractive index between the optical paths 31 to 38, optical paths 43A to 48H in the optical wiring paths 51 to 58 and the other portions by means of, for example, glass, a semiconductor, or polymer, the optical waveguides can confine light in the optical paths 31 to 38 and the optical paths 43A to 48H to perform signal transmission.

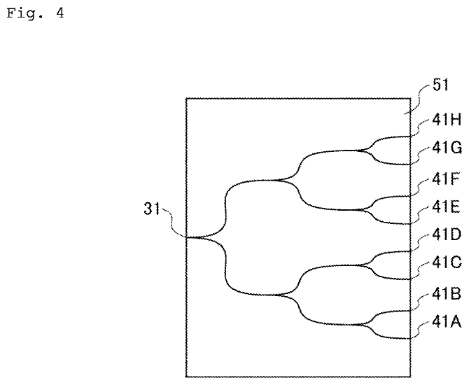

FIG. 4 is a diagram showing an example of a configuration of the optical wiring path 51 provided in the multi-core optical wiring module 100 shown in FIGS. 2 and 3. As shown in FIG. 4, the optical wiring path 51 is formed in a single plate shape, and includes a plurality of optical paths 31 and 41A to 41H. One optical path 31 is branched inside the optical wiring path 51, which are then arranged so as to be connected to the plurality of optical paths 41A to 41H. The optical wiring path 51 connects an optical fiber connected to the optical path 31 and optical fibers connected to the optical paths 41A to 41H. Also, the optical wiring path 52 is formed in a single plate shape as with the optical wiring path 51, and is provided with a plurality of optical paths 32 and 42A to 42H. One optical path 32 is branched inside the optical wiring path 52, which are then arranged so as to be connected to the plurality of optical paths 42A to 42H. The optical wiring paths 53 to 58 are also constructed in the same manner as the optical wiring path 51. In the multi-core optical wiring module 100, the plurality of optical wiring paths 51 to 58 formed into a plate shape are stacked and arranged in the thickness direction, thereby realizing a configuration capable of reducing the intersections of the respective optical paths 31 to 38 and 43A to 48H and suppressing the occurrence of crosstalk between optical paths.

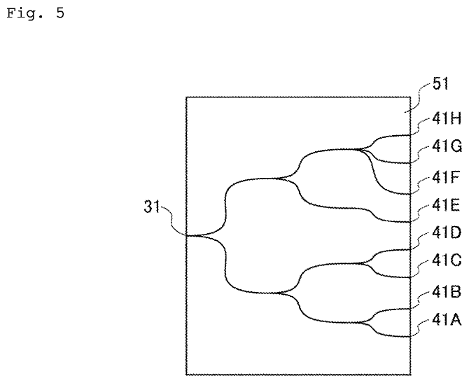

Although FIG. 4 shows an example of a splitter module for branching one optical path 31 into eight optical paths 41A to 41H in the optical wiring path 51, it is sufficient that one or more optical paths for connecting optical fibers are formed, and for example, the optical path shown in FIG. 5 instead of FIG. 4 may be provided. In the optical wiring path 51, the optical path 31 and any one or more of the optical paths 41A to 41H may be connected according to the purpose. The same applies to the optical wiring paths 52 to 58.

As shown in FIG. 2, the optical wiring paths 51 to 58 may be provided with identification marks 71 to 78 for identifying the respective optical wiring paths 51 to 58. The optical wiring paths 51 to 58 are identified by the identification marks 71 to 78, respectively, and the optical wiring paths 51 to 58 are stacked in the order corresponding to the identification marks 71 to 78, thereby preventing the occurrence of erroneous connection in the final connection to a plurality of routes having the plurality of optical fibers. For the identification marks 71 to 78, the order in which the optical wiring paths 51 to 58 are stacked may only need to be clarified, and there are no limits to numerals.

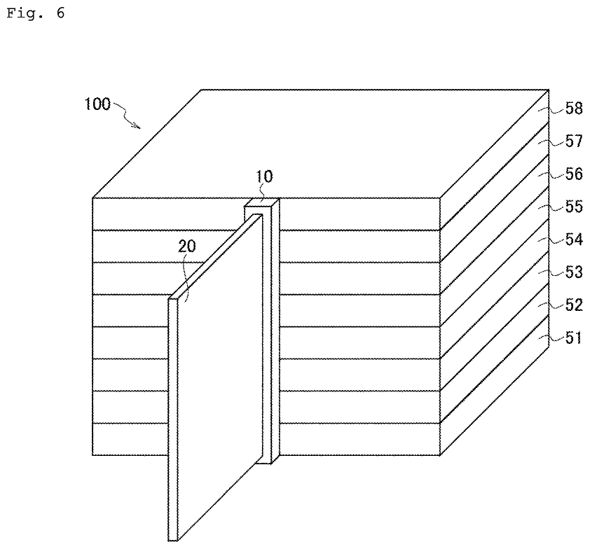

FIG. 6 is a diagram showing an example of an image representing an optical connection portion of the first side surfaces of the optical wiring paths 51 to 58 of the multi-core optical wiring module 100. The optical paths 31 to 38 of the multi-core optical wiring module 100 are connected to the optical fiber cable 20 through the multi-core optical connector 10 as an optical connection portion.

The optical fiber cable 20 may be composed of an optical fiber tape obtained by bundling single-core optical fibers. For example, by adjusting the thickness of the optical wiring paths 51 to 58 to a fiber arrangement interval of the multi-core optical connector, an MT connector, also referred to as an F12-type multi-core optical fiber connector, can be used.

In a case where the optical paths 31 to 38 of the optical wiring paths 51 to 58 are formed by the optical fibers, the fiber end face of the optical fiber cable 20 and the end faces of the optical fibers constituting the optical paths 31 to 38 of the optical wiring paths 51 to 58 can physically be brought into contact with each other by the multi-core optical connector 10 applying pressure by a spring (not shown), whereby connection loss can be reduced, and a high reflection attenuation amount can be realized.

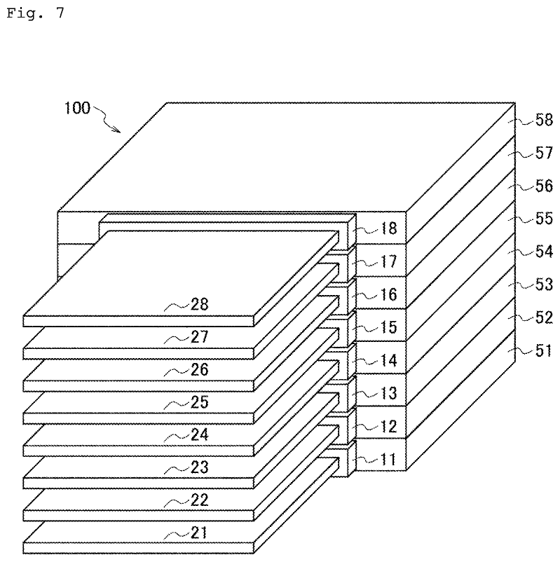

FIG. 7 is a diagram showing an example of an image representing optical connection portions of the optical wiring paths 51 to 58 of the multi-core optical wiring module 100. FIG. 7 is a diagram showing a second side surface which is a side surface facing the first side surface of the multi-core optical wiring module 100 shown in FIG. 6. The optical paths 41A to 48H of the multi-core optical wiring module 100 are connected to the optical fiber cables 21 to 28 through the multi-core optical connectors 11 to 18 functioning as the optical connection portions. In FIG. 7, the multi-core optical connectors 11 to 18 are connected to the optical paths 41A to 48H of one corresponding optical wiring path 51 to 58. For example, the multi-core optical connector 11 is connected to the optical path 41A to 41H of the corresponding optical wiring path 51, and the multi-core optical connector 12 is connected to the optical path 42A to 42H of the corresponding optical wiring path 52. By using the multi-core optical wiring module 100, splitter modules can be manufactured in a batch in the optical fibers in the respective multi-core optical connectors 11 to 18 of the optical fiber cables 21 to 28. For example, by adjusting the spacing of the optical paths 41A to 48H of the respective optical wiring paths 51 to 58 to the fiber arrangement interval of the multi-core optical connectors 11 to 18, an MT connector, also referred to as an F12-type multi-core optical fiber connector, can be used.

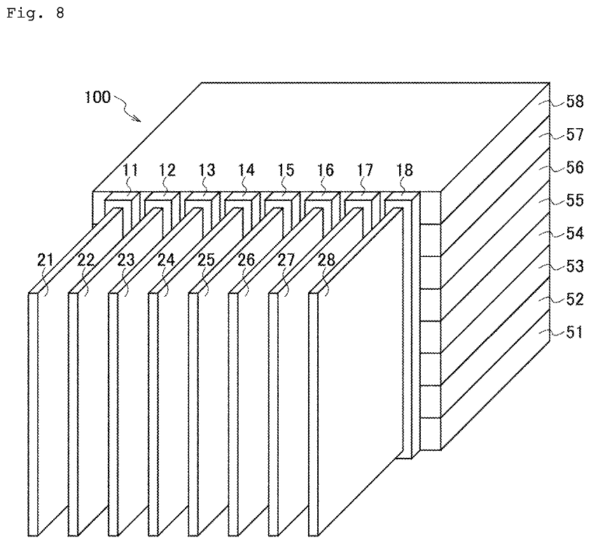

FIG. 8 is a diagram showing an example of another image representing an optical connection portion of the optical wiring paths 51 to 58 of the multi-core optical wiring module 100. FIG. 8 is a diagram showing the second side surface of the multi-core optical wiring module 100 as in FIG. 7. FIG. 8 shows a configuration in which each optical fiber (not shown) of the optical fiber cable 20 can be branched into each of the optical fiber cables 21 to 28. The optical paths 41A to 48H of the multi-core optical wiring module 100 are connected to the optical fiber cables 21 to 28 through the multi-core optical connectors 11 to 18 functioning as the optical connection portions. In FIG. 8, each of the multi-core optical connectors 11 to 18 is connected to one corresponding optical path 41A to 48H of each of the optical wiring paths 51 to 58. For example, the multi-core optical connector 11 is connected to one corresponding optical path 41A to 48A of each of the optical wiring paths 51 to 58, and the multi-core optical connector 12 is connected to one corresponding optical path 41B to 48B of each of the optical wiring paths 51 to 58. For example, by adjusting the thickness of each of the optical wiring paths 51 to 58 to the fiber arrangement interval of the multi-core optical connectors 11 to 18, an MT connector, also referred to as an F12-type multi-core optical fiber connector, can be used.

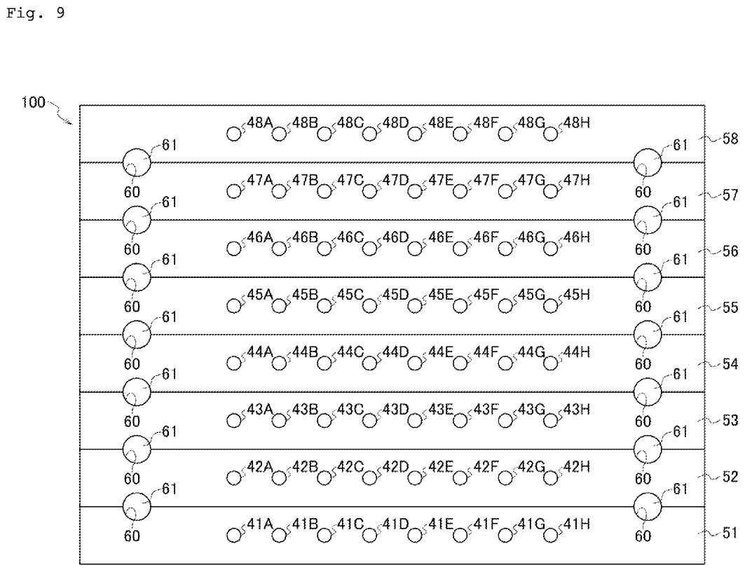

FIG. 9 is a diagram showing an example of an image representing connection end faces between the optical wiring paths 51 to 58 of the multi-core optical wiring module 100 and the optical connection portions. By suppressing misalignment of each of the optical paths 31 to 38 and 41A to 48H, excessive loss in the optical connection portions can be reduced. For example, circular grooves 60 into which optical wiring path adjusting pins 61 are inserted may be provided between the adjacent optical wiring paths 51 to 58. By inserting and arranging the optical wiring path adjusting pins 61 into holes formed of the respective circular grooves 60, the positions of the respective adjacent optical wiring paths 51 to 58 can be adjusted by the optical wiring path adjusting pins 61 to prevent misalignment of the optical paths 31 to 38 and 41A to 48H.

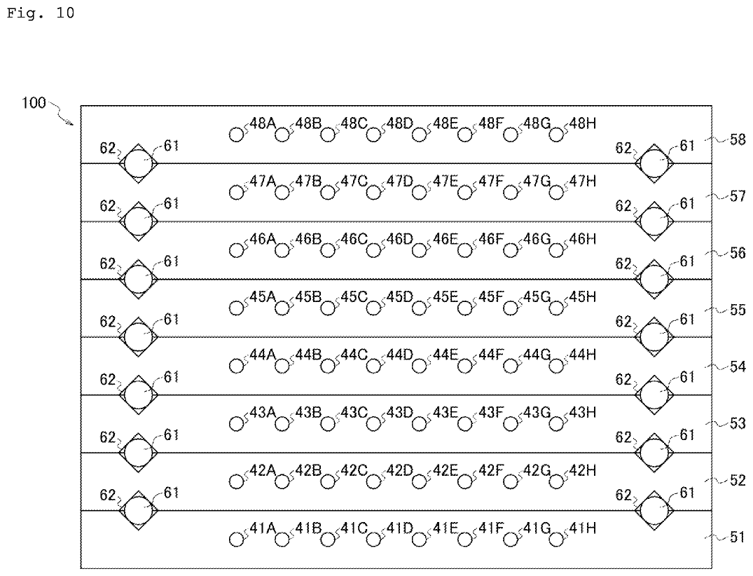

FIG. 10 is a diagram showing another example of an image representing the connection end faces between the optical wiring paths 51 to 58 of the multi-core optical wiring module 100 and the optical connection portions. V-grooves 62 for inserting the optical wiring path adjusting pins 61 may be provided between the adjacent optical wiring paths 51 to 58.

By inserting and arranging the optical wiring path adjusting pins 61 into holes formed of the respective V-grooves 62, the positions of the respective adjacent optical wiring paths 51 to 58 can be adjusted by the optical wiring path adjusting pins 61 to prevent misalignment of the optical paths 31 to 38 and 41A to 48H.

As described above, according to the multi-core optical wiring module 100 according to the first embodiment, the plurality of optical wiring paths 51 to 58 formed in a plate shape are stacked and arranged in the thickness direction, whereby the intersections of the optical paths 31 to 38 and 43A to 48H can be reduced. Therefore, the multi-core optical wiring module 100 can achieve a configuration capable of suppressing the occurrence of crosstalk between optical paths. Moreover, the multi-core optical wiring module 100 can be reduced in size while suppressing the occurrence of crosstalk between optical paths. In addition, by preparing and selecting a plurality of optical wiring paths 51 to 58 having different wiring configurations in advance, the connection destination for each single core of the optical fiber cable can be freely constituted.

Further, according to the multi-core optical wiring module 100 according to the first embodiment, the identification mark 71 to 78 are provided on the optical wiring paths 51 to 58, and the optical wiring paths 51 to 58 are stacked in the order corresponding to the identification marks 71 to 78, whereby erroneous connection due to an erroneous stacking order can be prevented.

### Second Embodiment

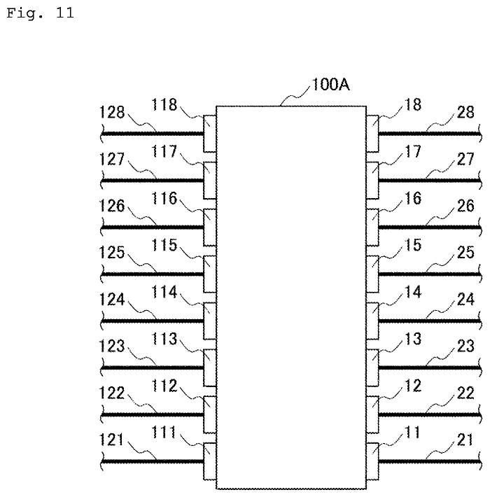

FIG. 11 is a diagram showing an example of a form of connection of a multi-core optical wiring module 100A according to a second embodiment. As shown in FIG. 11, the multi-core optical wiring module 100A realizes optical communication between optical fiber cables 121 to 128 and the optical fiber cables 21 to 28 by connecting multi-core optical connectors 111 to 118 and the multi-core optical connectors 11 to 18.

As the multi-core optical connectors 11 to 18 and 111 to 118, for example, an MT connector, also referred to as an F12-type multi-core optical fiber connector, may be used. The optical fiber cables 21 to 28 and 121 to 128 to be attached to the MT connectors are bonded and fixed to optical fiber insertion holes of MT ferrules. Connection end faces of core wires of the optical fiber cables 21 to 28 and 121 to 128 are polished at right angle. The optical fiber cables 21 to 28 and 121 to 128 may be provided in pigtail. The MT connector is connected by filling the gap between the end faces with a refractive index matching agent, inserting a guide pin (not shown) attached to one MT ferrule into a guide pin hole (not shown) of the other MT ferrule, and fitting the MT ferrules together.

For the multi-core optical connectors 11 to 18 and 111 to 118, an MPO connector, also referred to as an F13-type multi-core optical fiber connector, may be used instead of the MT connector. In this case, the end faces of the MT ferrules are polished obliquely, the MT ferrules are built in an MPO plug housing, and an MPO plug is connected in an MPO adapter. The multi-core optical connectors 11 to 18 and 111 to 118 may only be required to connect a plurality of coated optical fibers collectively and detachably, and are not limited to MT connectors and MPO connectors.

Although FIG. 11 shows a form of connecting eight optical fiber cables 121 to 128 and eight optical fiber cables 21 to 28, the present disclosure is not limited thereto; one or more optical fiber cables may be connected to each other.

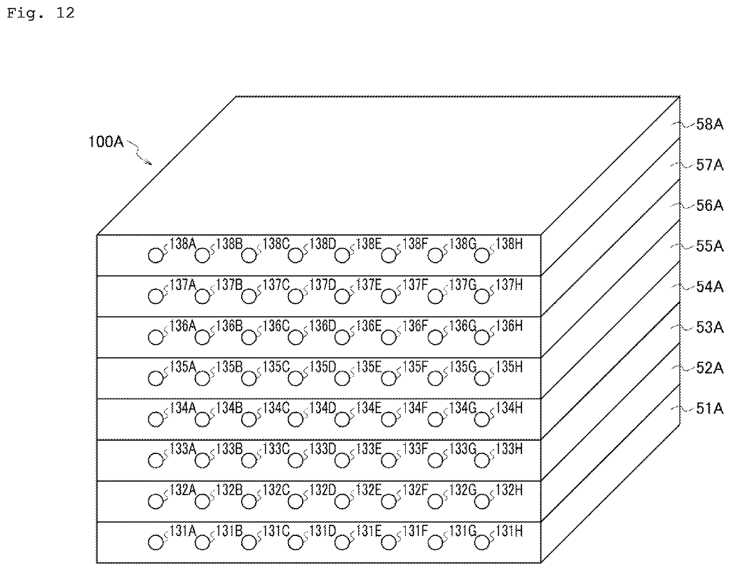

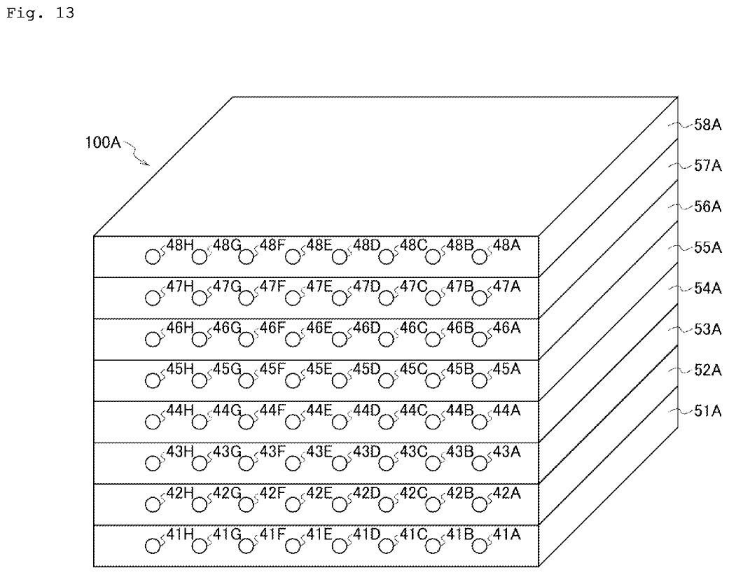

FIG. 12 is a diagram showing a configuration example of a first side surface of the multi-core optical wiring module 100A. FIG. 13 is a diagram showing a second side surface facing the first side surface of the multi-core optical wiring module 100A. FIG. 11 corresponds to a view of the multi-core optical wiring module 100A shown in FIGS. 12 and 13 when viewed from the lower side. The multi-core optical wiring module 100A is provided with a plurality of (eight, in FIGS. 12 and 13) optical wiring paths 51A to 58A, optical paths 131A to 138H, and optical paths 41A to 48H. In the multi-core optical wiring module 100A, the plurality of optical wiring paths 51A to 58A having the same thickness are stacked and arranged in the thickness direction. The number of optical wiring paths 51A to 58A may be 2 or more, and can be arbitrarily set. The respective optical wiring paths 51A to 58A may have different thicknesses.

A plurality of (eight, in FIG. 12) corresponding optical paths 131A to 138H are provided in a straight line at equal intervals on the first side surface of each of the optical wiring paths 51A to 58A. For example, in the optical wiring path 51A, a plurality of (eight, in FIG. 12) corresponding optical paths 131A to 131H are provided in a straight line at equal intervals. Also, in the optical wiring path 52A, a plurality of (eight, in FIG. 12) corresponding optical paths 132A to 132H are provided in a straight line at equal intervals. In the optical wiring paths 53A to 58A as well, the optical paths 133A to 138H are provided, as in the optical wiring paths 51A, 52A. The optical paths 131A to 138H of the adjacent optical wiring paths 51A to 58A are provided so as to be adjacent to each other in a straight line. For example, the optical paths 131A to 138A and the optical paths 131B to 138B of the adjacent optical wiring paths 51A to 58A are provided so as to be adjacent to each other in a straight line.

A plurality of (eight, in FIG. 13) corresponding optical paths 41A to 48H are provided in a straight line at equal intervals on the second side surface of each of the optical wiring paths 51A to 58A. For example, in the optical wiring path 51A, a plurality of (eight, in FIG. 13) corresponding optical paths 41A to 41H are provided in a straight line at equal intervals. Also, in the optical wiring path 52A, a plurality of (eight, in FIG. 13) corresponding optical paths 42A to 42H are provided in a straight line at equal intervals. In the optical wiring paths 53 to 58 as well, the optical paths 43A to 48H are provided, as in the optical wiring paths 51, 52. The optical paths 41A to 48H of the adjacent optical wiring paths 51A to 58A are provided so as to be adjacent to each other in a straight line. For example, the optical paths 41A to 48A and the optical paths 41B to 48B of the adjacent optical wiring paths 51A to 58A are provided so as to be adjacent to each other in a straight line.

The optical paths 131A to 138H are connected to the optical fiber cables 121 to 128 through the multi-core optical connectors 111 to 118. For example, the optical paths 131A to 138A are connected to the optical fiber cable 121 through the multi-core optical connector 111. The optical paths 131B to 138B are connected to the optical fiber cable 122 through the multi-core optical connector 112. The remaining optical paths 133A to 138H are similarly connected to the optical fiber cables 123 to 128 through the multi-core optical connectors 113 to 118.

The optical paths 41A to 48H are connected to the optical fiber cables 21 to 28 through the multi-core optical connectors 11 to 18. For example, the optical paths 41A to 48A are connected to the optical fiber cable 21 through the multi-core optical connector 11. The optical paths 41B to 48B are connected to the optical fiber cable 22 through the multi-core optical connector 12. The remaining optical paths 43A to 48H are similarly connected to the optical fiber cables 23 to 28 through the multi-core optical connectors 13 to 18.

For example, the optical paths 131A to 138H and 41A to 48H may be formed of optical fibers that are arranged with a level of bending where signal deterioration does not occur due to bending loss. For example, in a case where a single mode optical fiber whose bending loss does not increase with respect to bending of 30 mm radius is used, the optical fibers are bent and arranged in a size equivalent to a radius of 30 mm or more. For example, in a case where an optical fiber whose bending loss is reduced with respect to bending of 15 mm radius is used, the bending radius for arranging the optical fibers can be reduced to 15 mm. In this case, for example, the optical wiring paths 51A to 58A may be formed in a sheet shape of a material such as a polymer compound, and the optical fibers functioning as the optical paths may be arranged and filled with a resin.

In addition, the optical wiring paths 51A to 58A may be formed of a solid such as glass material, plastic solid, or metal. In a case where the optical wiring paths 51A to 58A are formed of a solid, the optical wiring paths 51A to 58A may be formed by manufacturing the respective optical wiring paths 51A to 58A in an upper portion and a lower portion, providing V grooves (not shown) in the respective optical wiring paths, arranging the optical fibers serving as the optical paths 131A to 138H and 41A to 48H along the V grooves, and bonding and fixing them. Although the V grooves are provided in the optical wiring paths 51A to 58A, the present disclosure is not limited to this configuration. The optical wiring paths 51A to 58A may be formed by sandwiching the optical fibers, and the grooves may have a rectangular or curved surface shape.

Instead of constituting the optical paths 131A to 138H and 41A to 48H with the optical fibers, the optical paths may be composed of optical waveguides. By providing a difference in refractive index between the optical paths 131A to 138H and 41A to 48H in the optical wiring paths 51A to 58A and the other portions by means of, for example, glass, a semiconductor, or polymer, the optical waveguides can confine light in the optical paths 131A to 138H and 41A to 48H to perform signal transmission.

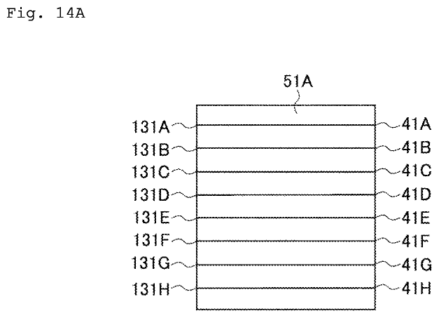

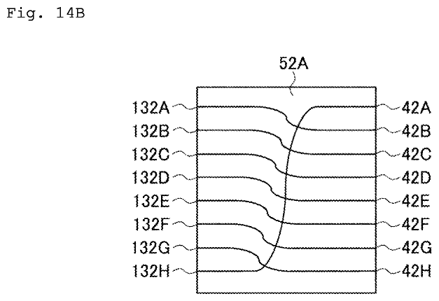

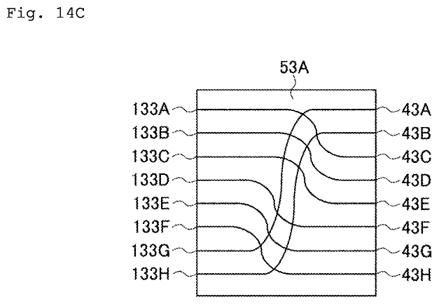

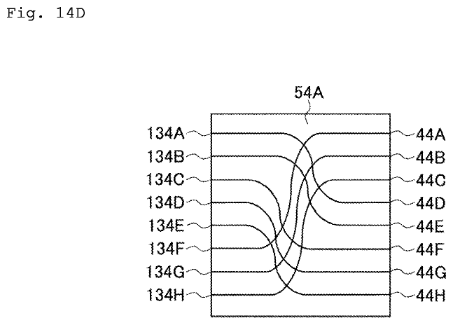

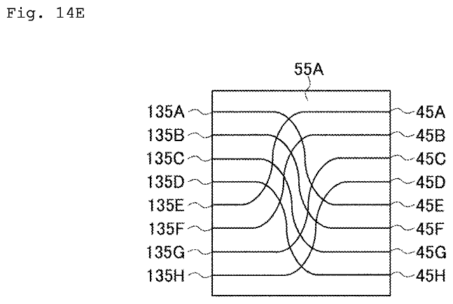

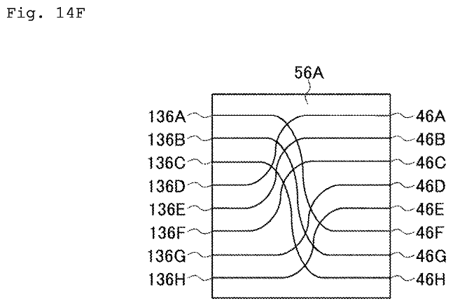

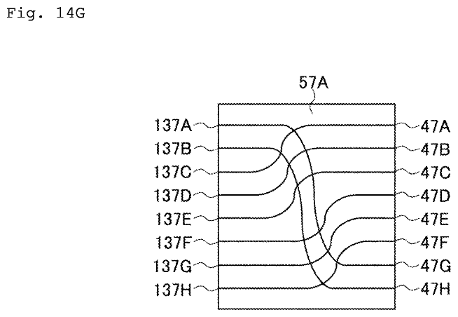

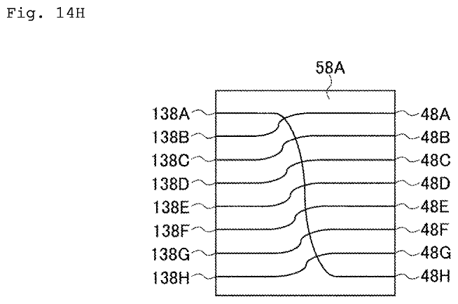

FIGS. 14A to 14H show examples of the configuration of the optical wiring paths 51A to 58A provided in the multi-core optical wiring module 100A. As shown in FIGS. 14A to 14H, the optical wiring paths 51A to 58A have a plurality of optical paths 131A to 138H and 41A to 48H, respectively. The optical paths 131A to 138H and the optical paths 41A to 48H are arranged so as to be connected to each other inside the optical wiring paths 51A to 58A. For example, as shown in FIG. 14A, inside the optical wiring path 51A, the optical path 131A is connected to the optical path 41A, the optical path 131B to the optical path 41B, the optical path 131C to the optical path 41C, the optical path 131D to the optical path 41D, the optical path 131E to the optical path 41E, the optical path 131F to the optical path 41F, the optical path 131G to the optical path 41G, and the optical path 131H to the optical path 41H. Further, as shown in FIG. 14B, inside the optical wiring path 52A, the optical path 132A is connected to the optical path 42B, the optical path 132B to the optical path 42C, the optical path 132C to the optical path 42D, the optical path 132D to the optical path 42E, the optical path 132E to the optical path 42F, the optical path 132F to the optical path 42G, the optical path 132G to the optical path 42H, and the optical path 132H to the optical path 42A. Similarly, inside the optical wiring paths 53A to 58A as well, the optical paths 133A to 138H and the optical paths 43A to 48H are connected to each other as shown in FIGS. 14C to 14H. Note that the present disclosure is not limited thereto, and each of the optical wiring paths 51A to 58A may be provided with one or more optical paths according to the purpose.

As described above, according to the multi-core optical wiring module 100A according to the second embodiment, the plurality of optical wiring paths 51A to 58A formed in a plate shape are stacked and arranged in the thickness direction, whereby the intersections of the optical paths 131A to 138H and 43A to 48H can be reduced. Therefore, the multi-core optical wiring module 100A can achieve a configuration capable of suppressing the occurrence of crosstalk between optical paths. Moreover, the multi-core optical wiring module 100A can be reduced in size due to its ability to suppress the occurrence of crosstalk between optical paths. In addition, by preparing and selecting a plurality of optical wiring paths 51A to 58A having different wiring configurations in advance, the connection destination for each single core of the optical fiber cable can be freely constituted.

Although FIGS. 14A to 14H show a configuration in which the optical paths 131A to 138H can be connected in matrix to the optical paths 41A to 48H, the present disclosure is not limited thereto; one or more optical paths can be provided so as to obtain a desired optical wiring form.

In the second embodiment as well, as shown in FIG. 9, the circular grooves 60 into which the optical wiring path adjusting pins 61 are inserted may be provided between the adjacent optical wiring paths 51A to 58A, as in the first embodiment. By inserting and arranging the optical wiring path adjusting pins 61 into holes formed of the respective circular grooves 60, the positions of the respective adjacent optical wiring paths 51A to 58A can be adjusted by the optical wiring path adjusting pins 61 to prevent misalignment of the optical paths 131A to 138H and 41A to 48H. By preventing misalignment of the optical paths 131A to 138H and 41A to 48H of the optical wiring paths 51A to 58A, excessive loss in the optical connection portions can be reduced. Also, as shown in FIG. 10, the V-grooves 62 for inserting the optical wiring path adjusting pins 61 may be provided between the adjacent optical wiring paths 51A to 58A. By inserting and arranging the optical wiring path adjusting pins 61 into holes formed of the respective V-grooves 62, the positions of the respective adjacent optical wiring paths 51A to 58A can be adjusted by the optical wiring path adjusting pins 61 to prevent misalignment of the optical paths 131A to 138H and 41A to 48H. Also in the second embodiment as well, the identification mark 71 to 78 shown in FIG. 2 are provided on the optical wiring paths 51A to 58A, and the optical wiring paths 51A to 58A are stacked in the order corresponding to the identification marks 71 to 78, whereby erroneous connection due to an erroneous stacking order can be prevented.

### Third Embodiment

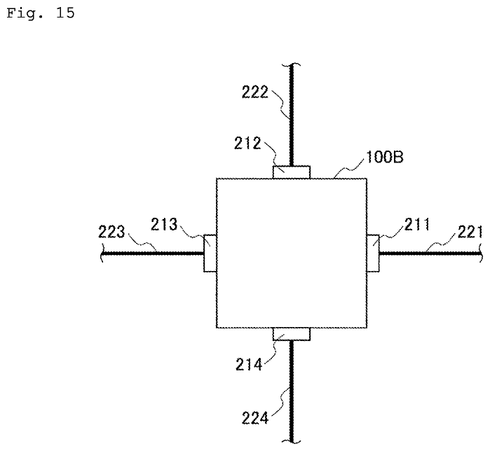

FIG. 15 is a diagram showing an example of a form of connection of a multi-core optical wiring module 100B according to a third embodiment. As shown in FIG. 15, the multi-core optical wiring module 100B realizes optical communication between optical fiber cables 221 to 224 by connecting multi-core optical connectors 211 to 214, respectively.

As the multi-core optical connectors 211 to 214, for example, an MT connector, also referred to as an F12-type multi-core optical fiber connector, may be used. The optical fiber cables 221 to 224 to be attached to the MT connectors are bonded and fixed to optical fiber insertion holes of MT ferrules. Connection end faces of core wires of the optical fiber cables 221 to 224 are polished at right angle. The optical fiber cables 221 to 224 may be provided in pigtail. The MT connector is connected by filling the gap between the end faces with a refractive index matching agent, inserting a guide pin (not shown) attached to one MT ferrule into a guide pin hole (not shown) of the other MT ferrule, and fitting the MT ferrules together.

For the multi-core optical connectors 211 to 214, an MPO connector, also referred to as an F13-type multi-core optical fiber connector, may be used in place of the MT connector. In this case, the end faces of the MT ferrules are polished obliquely, the MT ferrules are built in an MPO plug housing, and an MPO plug is connected in an MPO adapter. The multi-core optical connectors 211 to 214 may only be required to connect a plurality of optical fibers collectively and detachably, and are not limited to MT connector and MPO connector.

Although FIG. 15 shows a form of connecting one optical fiber cable 221 to 224 is connected to each side surface of the multi-core optical wiring module 100B, the present disclosure is not limited thereto; one or more optical fiber cables may be connected to each other.

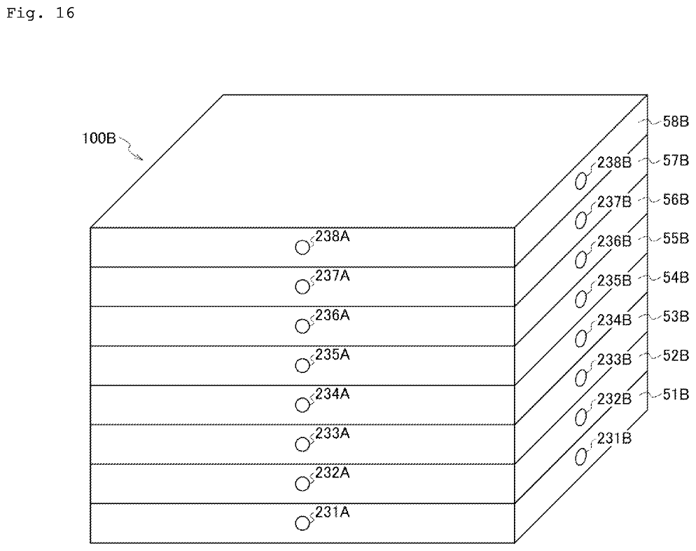

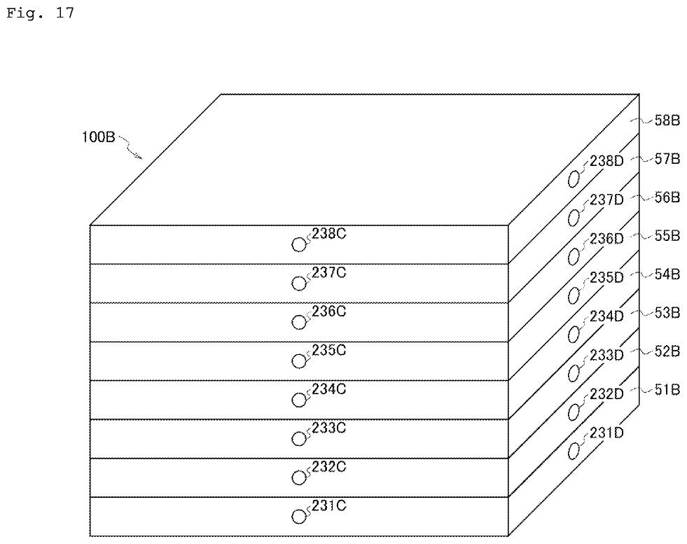

FIG. 16 is a diagram showing a configuration example of a first side surface of the multi-core optical wiring module 100B and a third side surface adjacent thereto. The multi-core optical wiring module 100B is provided with optical wiring paths 51B to 58B and optical paths 231A to 238D. FIG. 17 is a diagram showing a configuration example of a second side surface facing the side surface of the multi-core optical wiring module 100B shown in FIG. 16, and a fourth side surface adjacent thereto. The multi-core optical wiring module 100B is provided with a plurality of (eight, in FIGS. 16 and 17) optical wiring paths 51B to 58B, and optical paths 231A to 238A, 231B to 238B, 231C to 238C, 231D to 238D. In the multi-core optical wiring module 100B, the plurality of optical wiring paths 51B to 58B having the same thickness are stacked and arranged in the thickness direction. The number of optical wiring paths 51B to 58B may be 2 or more, and can be arbitrarily set. The respective optical wiring paths 51B to 58B may have different thicknesses.

One corresponding optical path 231A to 238A is provided on the first side surface of each of the optical wiring paths 51B to 58B. The optical paths 231A to 238A on the first side surfaces of the adjacent optical wiring paths 51B to 58B are provided so as to be adjacent to each other in a straight line.

One corresponding optical path 231C to 238C is provided on the second side surface facing the first side surface of each of the optical wiring paths 51B to 58B. The optical paths 231C to 238C of the second side surfaces of the adjacent optical wiring paths 51B to 58B are provided so as to be adjacent in a straight line.

One corresponding optical path 231B to 238B is provided on the third side surface of each of the optical wiring paths 51B to 58B. The optical paths 231B to 238B on the third side surfaces of the adjacent optical wiring paths 51B to 58B are provided so as to be adjacent in a straight line.

One corresponding optical path 231D to 238D is provided on the fourth side surface facing the third side surface of each of the optical wiring paths 51B to 58B. The optical paths 231D to 238D on the fourth side surfaces of the adjacent optical wiring paths 51B to 58B are provided so as to be adjacent to each other in a straight line.

The optical paths 231A to 238A are connected to the optical fiber cable 221 through the multi-core optical connector 211.

The optical paths 231B to 238B are connected to the optical fiber cable 222 through the multi-core optical connector 212.

The optical paths 231C to 238C are connected to the optical fiber cable 223 through the multi-core optical connector 213.

The optical paths 231D to 238D are connected to the optical fiber cable 224 through the multi-core optical connector 214.

For example, the optical paths 231A to 238D may be formed of optical fibers that are arranged with a level of bending where signal deterioration does not occur due to bending loss. For example, in a case where a single mode optical fiber whose bending loss does not increase with respect to bending of 30 mm radius is used, the optical fibers are bent and arranged in a size equivalent to a radius of 30 mm or more. For example, in a case where an optical fiber whose bending loss is reduced with respect to bending of 15 mm radius is used, the bending radius for arranging the optical fibers can be reduced to 15 mm. In this case, for example, the optical wiring paths 51B to 58B may be formed in a sheet shape of a material such as a polymer compound, and the optical fibers functioning as the optical paths may be arranged and filled with a resin.

The optical wiring paths 51B to 58B may be formed of a solid such as glass material, plastic solid, or metal. In a case where the optical wiring paths 51B to 58B are formed of a solid, the optical wiring paths 51B to 58B may be formed by manufacturing the respective optical wiring paths 51B to 58B in an upper portion and a lower portion, providing V grooves (not shown) in the respective optical wiring paths, arranging the optical fibers serving as the optical paths 231A to 238D along the V grooves, and bonding and fixing them. Although the V grooves are provided in the optical wiring paths 51B to 58B, the present disclosure is not limited to this configuration. The optical wiring paths 51B to 58B may be formed by sandwiching the optical fibers, and the grooves may have a rectangular or curved surface shape.

Instead of constituting the optical paths 231A to 238D with the optical fibers, the optical paths 231A to 238D may be composed of optical waveguides. By providing a difference in refractive index between the optical paths in the optical wiring paths and the other portions by means of, for example, glass, a semiconductor, or polymer, the optical waveguides can confine light in the optical paths to perform signal transmission.

In FIGS. 16 and 17, the optical fibers in the optical fiber cables 221 to 224 shown in FIG. 15 are 8 cores, but the present disclosure is not limited thereto, and the optical fibers may be 3 cores or more.

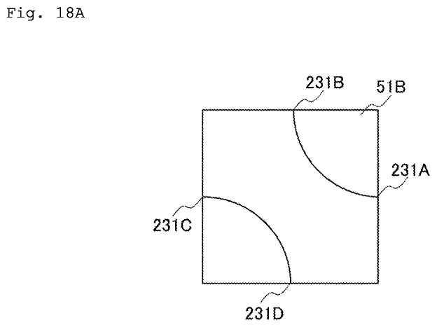

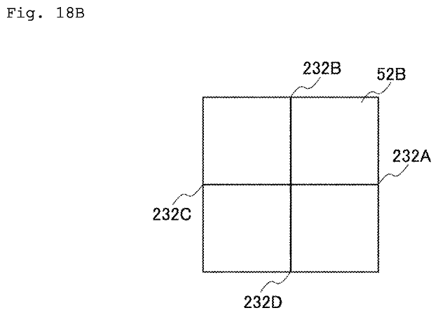

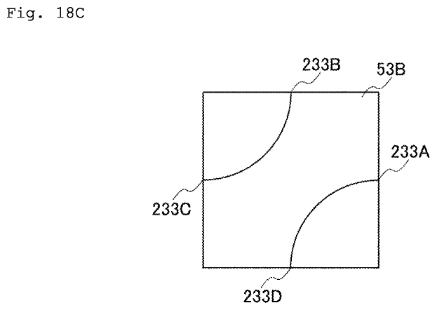

FIGS. 18A to 18C show examples of the configuration of the optical wiring paths 51B to 53B provided in the multi-core optical wiring module 100B. The optical wiring paths 51B to 53B are provided with a plurality of optical paths 231A to 233A, 231B to 233B, 231C to 233C, and 231D to 233D, respectively, as shown in FIGS. 16 and 17. For example, as shown in FIG. 18A, inside the optical wiring path 51B, the optical path 231A is connected to the optical path 231B, and the optical path 231C to the optical path 231D. Inside the optical wiring path 52B, as shown in FIG. 18B, the optical path 232A is connected to the optical path 232C, and the optical path 232B to the optical path 232D. Inside the optical wiring path 53B, as shown in FIG. 18C, the optical path 233A is connected to the optical path 233D, and the optical path 233B to the optical path 233C. In the optical wiring paths 54B to 58B as well, the optical paths 234A to 238D are similarly arranged so as to be connected according to the purpose. Note that the present disclosure is not limited thereto, and each of the optical wiring paths 51B to 58B may be provided with one or more optical paths according to the purpose.

As described above, according to the multi-core optical wiring module 100B according to the third embodiment, the plurality of optical wiring paths 51B to 58B formed in a plate shape are stacked and arranged in the thickness direction, whereby the intersections of the optical paths 231A to 238H can be reduced. Therefore, the multi-core optical wiring module 100B can achieve a configuration capable of suppressing the occurrence of crosstalk between optical paths. Moreover, the multi-core optical wiring module 100B can be reduced in size due to its ability to suppress the occurrence of crosstalk between optical paths. In addition, by preparing and selecting a plurality of optical wiring paths 51B to 58B having different wiring configurations in advance, the connection destination for each single core of the optical fiber cable can be freely constituted.

In the third embodiment as well, as shown in FIG. 9, the circular grooves 60 into which the optical wiring path adjusting pins 61 are inserted may be provided between the adjacent optical wiring paths 51B to 58B, as in the first embodiment. By inserting and arranging the optical wiring path adjusting pins 61 into holes formed of the respective circular grooves 60, the positions of the respective adjacent optical wiring paths 51B to 58B can be adjusted by the optical wiring path adjusting pins 61 to prevent misalignment of the optical paths 231A to 233D. By preventing misalignment of the optical paths 231A to 233D of the optical wiring paths 51B to 58B, excessive loss in the optical connection portions can be reduced. Also, as shown in FIG. 10, the V-grooves 62 for inserting the optical wiring path adjusting pins 61 may be provided between the adjacent optical wiring paths 51B to 58B. By inserting and arranging the optical wiring path adjusting pins 61 into holes formed of the respective V-grooves 62, the positions of the respective adjacent optical wiring paths 51B to 58B can be adjusted by the optical wiring path adjusting pins 61 to prevent misalignment of the optical paths 231A to 233D. Also in the third embodiment as well, the identification mark 71 to 78 shown in FIG. 2 are provided on the optical wiring paths 51B to 58B, and the optical wiring paths 51B to 58B are stacked in the order corresponding to the identification marks 71 to 78, whereby erroneous connection due to an erroneous stacking order can be prevented.

The descriptions and drawings that form part of this disclosure should not be understood as limiting the present invention. Various alternative embodiments, examples, and operational techniques will be apparent from this disclosure to a person skilled in the art.

### REFERENCE SIGNS LIST

100, 100A, 100B Multi-core optical wiring module
10 to 18 Multi-core optical connector
20 to 28 Optical fiber cable
31 to 38 Optical path
41A to 48H Optical path
51 to 58, 51A to 58A, 51B to 58B Optical wiring path
60 Circular groove
61 Optical wiring path adjusting pin (adjusting pin)
62 V-groove
71 to 78 Identification mark
111 to 118 Multi-core optical connector
121 to 128 Optical fiber cable
131A to 138H Optical path
211 to 214 Multi-core optical connector
221 to 224 Optical fiber cable
231A to 238D Optical path

1. A multi-core optical wiring module, comprising a plurality of plate-shaped optical wiring paths having one or more optical paths wherein the plurality of optical wiring paths are stacked in a thickness direction.

2. The multi-core optical wiring module according to claim 1, wherein the one or more optical paths are configured by optical fibers.

3. The multi-core optical wiring module according to claim 1, wherein the one or more optical paths are configured by optical waveguides.

4. The multi-core optical wiring module according to any claim 1, wherein a groove for inserting an adjusting pin is provided between adjacent optical wiring paths, and positions of the adjacent optical wiring paths can be adjusted by the adjusting pin inserted into a hole formed by the groove.

5. The multi-core optical wiring module according to any claim 1, wherein each of the plurality of optical wiring paths is provided with an identification mark for identifying each of the plurality of optical wiring paths, and the plurality of optical wiring paths are stacked in an order corresponding to the identification marks.
